(19) United States
(12) Patent Application Publication
(10) Pub. No.: US 2024/0340691 A1
(43) Pub. Date: Oct. 10, 2024

(54) METHOD AND APPARATUS FOR SELECTING BSR FORMAT IN WIRELESS COMMUNICATION SYSTEM

(71) Applicant: Samsung Electronics Co., Ltd., Suwon-si (KR)

(72) Inventors: Weiping SUN, Suwon-si (KR); Sangkyu BAEK, Suwon-si (KR); Hyunjeong KANG, Suwon-si (KR)

(21) Appl. No.: 18/627,048

(22) Filed: Apr. 4, 2024

(30) Foreign Application Priority Data
Apr. 5, 2023 (KR) 10-2023-0044812
Mar. 7, 2024 (KR) 10-2024-0032768

(51) Int. Cl. H04W 28/02; H04W 76/20; H04W 80/02

(52) U.S. Cl. CPC H04W 28/0278; H04W 76/20; H04W 80/02

(57) ABSTRACT

The disclosure relates to a 5G or 6G communication system for supporting a higher data transmission rate. Specifically, the disclosure provides a method and an apparatus in which a terminal and a base station transmit and receive a BSR according to a BSR format.

### CROSS-REFERENCE TO RELATED APPLICATIONS

This application is based on and claims priority under 35 U.S.C. 119 to Korean Patent Application No. 10-2023-0044812, filed on Apr. 5, 2023, and Korean Patent Application No. 10-2024-0032768, filed Mar. 7, 2024, both filed in the Korean Intellectual Property Office, the disclosures of which are herein incorporated by reference in their entirety.

### BACKGROUND

### 1. Field

The disclosure relates to wireless communications (or, mobile communications). More specifically, the disclosure relates to an operation of a terminal and a base station in wireless communications or mobile communications and, specifically to, a method for a buffer status report (BSR) of a terminal, a method for acquiring (or obtaining) a BSR by a base station, and a terminal, a base station, and a communication system related thereto.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the recent development of communication systems, there is a growing demand to improve BSR transmission and reception procedures.

The above information is presented as background information only to assist with an understanding of the disclosure. No determination has been made, and no assertion is made, as to whether any of the above might be applicable as prior art with regard to the disclosure.

### SUMMARY

The disclosed embodiments are to provide an apparatus and a method for effectively providing services in a wireless communication system. In particular, the disclosure provides a method and an apparatus for efficiently improving BSR transmission and reception procedures.

The technical subjects pursued in embodiments of the disclosure may not be limited to the above-mentioned technical subjects, and other technical subjects which are not mentioned may be clearly understood, through the following descriptions, by those skilled in the art to which the disclosure pertains.

The disclosure provides an apparatus and a method for effectively providing services in a wireless communication system.

According to an embodiment of the disclosure, a method performed by a terminal is provided. The method comprises: identifying a logical channel group (LCG) configured with an additional buffer size table; and in case that the LCG configured with the additional buffer size table has data available for transmission, transmitting, to a base station, a first long buffer status report (BSR), wherein the first long BSR corresponds to the additional buffer size table, and wherein an amount of the data available for transmission is within buffer sizes of the additional buffer size table.

According to an embodiment of the disclosure, a terminal is provided. The terminal comprises a transceiver; and a controller coupled with the transceiver and configured to: identify a logical channel group (LCG) configured with an additional buffer size table, and in case that the LCG configured with the additional buffer size table has data available for transmission, transmit, to a base station, a first long buffer status report (BSR), wherein the first long BSR corresponds to the additional buffer size table, and wherein an amount of the data available for transmission is within buffer sizes of the additional buffer size table.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a new radio (NR) system according to an embodiment of the disclosure;

FIG. 2 illustrates a radio protocol structure in an NR system according to an embodiment of the disclosure;

FIG. 3 illustrates a medium access control (MAC) subheader format in an NR system according to an embodiment of the disclosure;

FIG. 4 illustrates a short BSR/short truncated BSR MAC control element (CE) format of an NR system according to an embodiment of the disclosure;

FIG. 5 illustrates a long BSR/long truncated BSR MAC CE format of an NR system according to an embodiment of the disclosure;

FIG. 6 illustrates an extended short BSR MAC CE format of an NR system according to an embodiment of the disclosure;

FIG. 7 illustrates a procedure in which a base station and a terminal establish XR-Ext related configuration and whether the terminal supports XR-Ext via RRC signaling according to an embodiment of the disclosure;

FIG. 8 illustrates a structure of a terminal according to embodiments of the disclosure; and

FIG. 9 illustrates a structure of a base station according to embodiments of the disclosure.

### DETAILED DESCRIPTION

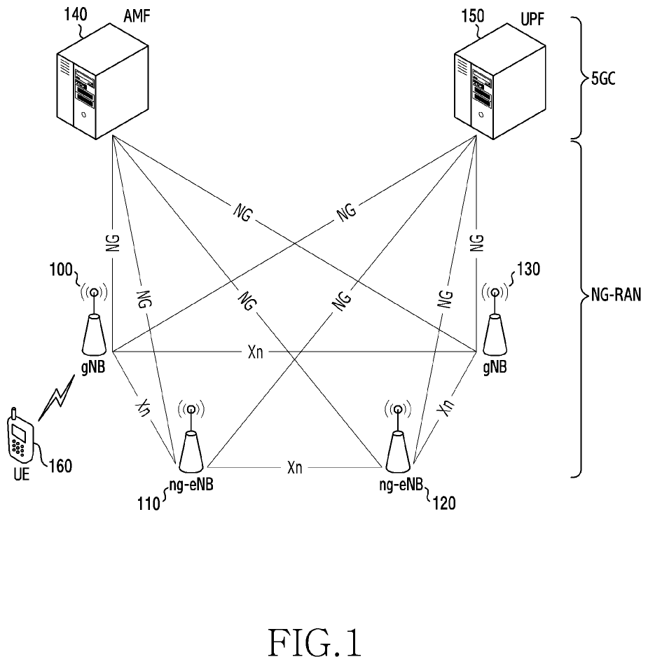

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, exemplary embodiments of the disclosure will be described in detail with reference to the accompanying drawings. It should be noted that, in the accompanying drawings, the same or like elements are designated by the same or like reference signs as much as possible. Furthermore, detailed descriptions of known functions or configurations that may make the subject matter of the disclosure unclear will be omitted.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are provided with the same or corresponding reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card.

In the following description, a base station is an entity that allocates resources to terminals, and may be at least one of a Node B, an eNode B (eNB), a gNode B (gNB), a wireless access unit, a base station controller, and a node on a network. A terminal may include a user equipment (UE), a mobile station (MS), a cellular phone, a smartphone, a computer, or a multimedia system capable of performing communication functions.

Furthermore, the embodiments of the disclosure as described below may also be applied to other communication systems having similar technical backgrounds or channel types to the embodiments of the disclosure. In addition, based on determinations by those skilled in the art, the embodiments of the disclosure may be applied to other communication systems through some modifications without significantly departing from the scope of the disclosure. Examples of other communication systems may include 5th generation mobile communication technologies (5G, new radio, NR) developed beyond LTE-A, and in the following description, the “5G” may be a concept that covers exiting LTE, LTE-A, and other similar services. In addition, based on determinations by those skilled in the art, the disclosure may be applied to other communication systems through some modifications without significantly departing from the scope of the disclosure.

In the following description, terms for identifying access nodes, terms referring to network entities or network functions (NFs), terms referring to messages, terms referring to interfaces between network entities, terms referring to various identification information, and the like are illustratively used for the sake of convenience. Therefore, the disclosure is not limited by the terms as used below, and other terms referring to subjects having equivalent technical meanings may be used.

In the following description, some of terms and names defined in the 3rd generation partnership project (3GPP) long term evolution (LTE) standards and/or 3GPP new radio (NR) standards may be used for the sake of descriptive convenience. However, the disclosure is not limited by these terms and names, and may be applied in the same way to systems that conform other standards.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a terminal (or UE) transmits data or control signals to a base station (BS) (or eNB, gNB), and the downlink indicates a radio link through which the base station transmits data or control signals to the terminal. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to an embodiment, e MBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the IoT provides communication functions while being provided to various sensors and various devices, the IoT must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The above-described three services considered in the 5G communication system, that is, eMBB, URLLC, and mMTC, may be multiplexed and transmitted in a single system. In order to satisfy different requirements of the respective services, different transmission/reception techniques and transmission/reception parameters may be used between services. However, the above mMTC, URLLC, and eMBB are merely examples of different types of services, and service types to which the disclosure is applied are not limited to the above examples.

Furthermore, in the following description, LTE, LTE-A, LTE Pro, 5G (or NR), or 6G systems will be described by way of example, but the embodiments of the disclosure may also be applied to other communication systems having similar technical backgrounds or channel types. In addition, based on determinations by those skilled in the art, the embodiments of the disclosure may be applied to other communication systems through some modifications without significantly departing from the scope of the disclosure.

In next-generation/5G (new radio (NR)) wireless communication systems, a terminal needs to report a buffer status to a base station to help more efficient resource scheduling of the base station. The buffer status report (BSR) is used to represent and report the amount of data stored in a buffer of a terminal. According to the specification of the NR, the terminal selects an interval index including an amount of buffer data to be reported in a range of a data amount for each interval, defined for each index in a buffer size table, and includes the selected interval index in the BSR.

However, the buffer size table as typically defined has been designed to represent a larger amount of data in a longer interval as the index value becomes larger. The larger the amount of data stored in the buffer of the terminal, the larger the index value that should be transmitted, and since the larger index value corresponds to the amount of data in a longer interval, the base station has difficulty identifying the exact amount of data in the corresponding interval, thus making efficient scheduling difficult.

Therefore, a new buffer size (BS) table (hereinafter referred to as an NBT) is proposed in the disclosure. In addition, with the introduction of the new buffer size table (NBT), the disclosure proposes a new BSR format that is able to refer to the NBT, and proposes a method in which a terminal selects and reports one of several BSR formats including the new BSR format depending on a situation.

Buffer status reporting in the NR system may be performed based on MAC layer signaling between a terminal and a base station. In other words, when BSR is triggered at a specific transmission time point, the terminal may include a BSR control element (MAC CE) in a MAC protocol data unit (MAC PDU) to transfer the same to the base station. The BSR control element indicates the number of packets in units of logical channel groups (LCGs), the packets being remained in a transmission buffer of the terminal after the corresponding MAC PDU has been configured. The base station may estimate the amount of data currently remaining in the buffer of the terminal by using the BSR received from the terminal. In the NR system, the terminal may manage, for each of 8 LCGs, a transmission buffer for data to be transmitted to the base station.

The disclosure proposes a method in which, in order to transfer the specific amount of data stored in a transmission buffer of a terminal to a base station, an NBT is introduced, and the terminal reports the buffer size to the base station by referring to the NBT.

The disclosure is to propose a method for improving communication performance of a terminal and a base station. Further, the disclosure is to propose a method for reporting a BSR by a terminal and a method for obtaining BSR by a base station.

Various embodiments of the disclosure may provide a method for improving communication performance of a terminal and a base station. Further, various embodiments of the disclosure may provide a method for reporting BSR by a terminal and a method for obtaining BSR by a base station.

FIG. 1 illustrates the structure of an NR system according to an embodiment of the disclosure.

Referring to FIG. 1, a wireless communication system may include multiple base stations (e.g., gNB 100, ng-eNB 110, ng-eNB 120, and gNB 130), an access and mobility management function (AMF) 140, and a user plane function (UPF) 150. Of course, the wireless communication system is not limited to the configuration shown in FIG. 1 and may include more or fewer elements.

According to an embodiment of the disclosure, a user equipment (hereinafter referred to as “UE” or “terminal”) 160 may access an external network through the base stations 100, 110, 120, 130 and the UPF 150.

In FIG. 1, the base stations 100, 110, 120, and 130 may serve as access nodes of a cellular network and provide wireless access to terminals accessing the network. That is, in order to serve traffic of users, the base stations 100, 110, 120, and 130 may collect status information, such as buffer status, available transmission power status, channel status, and the like of terminals, and perform scheduling, thereby supporting a connection between the terminals and a core network (CN, specifically, a CN of the NR is referred to as a 5GC).

In FIG. 1, gNBs 100 and 130 may control multiple cells and may apply an adaptive modulation & coding (AMC) method to determine a modulation scheme and a channel coding rate according to the channel state of the terminal.

The core network may serve as a device responsible for mobility management functions for terminals as well as various control functions and connected to multiple base stations. The 5GC may also be associated with existing LTE systems. In the following, each of functions included in the core network may be described as an entity or node.

On the other hand, in wireless communications, a user plane (UP) related to real user data transmission and a control plane (CP) such as connection management may be separately configured. In FIG. 1, the gNBs 100 and 130 may use UP and CP technology defined in NR technology, and although the ng-eNBs 110 and 120 are connected to a 5GC, the ng-eNBs may use UP and CP technology defined in the long-term evolution (LTE) technology.

The AMF 140 is a device configured to perform various control functions as well as a mobility management function for a terminal, and is connected to multiple base stations. The UPF 150 may refer to a kind of a gateway device for providing data transmission. Although not shown in FIG. 1, the NR wireless communication system may also include a session management function (SMF). The SMF may manage packet data network connections, such as PDU sessions provided to a terminal.

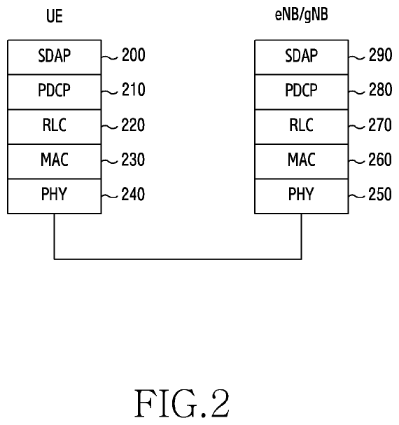

FIG. 2 illustrates a radio protocol structure in an NR/LTE system according to an embodiment of the disclosure.

Referring to FIG. 2, the radio protocols of the NR system may include service data adaptation protocols (SDAPs) 200 and 290, packet data convergence protocols (PDCPs) 210 and 280, radio link controls (RLCs) 220 and 270, and MACs 230 and 260 in a terminal and a base station, respectively.

The SDAPs 200 and 290 may perform operations of transferring user data and mapping quality of service (QOS) flows to specific data radio bearers (DRBs) for uplinks and downlinks, marking QoS flow IDs for uplinks and downlinks, and mapping reflective QoS flows to data bearers for uplink SDAP PDUs. The SDAP configurations corresponding to each DRB may be provided from a higher RRC layer. Of course, this is not limited to the above example.

The PDCPs 210 and 280 may be responsible for operations, such as compression/reconstruction of Internet protocol (IP) headers. In addition, the PDCPs 210 and 280 may provide sequential and non-sequential delivery functions, sequence reordering, duplicate detection, retransmission functions, encryption and decryption functions. Of course, the above examples are not limited.

The radio link controls (RLCs) 220 and 270 may reconfigure the PDCP PDUs to an appropriate size. The RLCs 220 and 270 may also provide in-sequence and out-of-sequence delivery functions, an automatic repeat request (ARQ) function, a concatenation, segmentation, and reassembly function, a re-segmentation function, a sequence reordering function, a duplicate detection function, and an error detection function. Of course, the above examples are not limited.

The MACs 230 and 260 may be connected to multiple RLC layer devices configured in one terminal, and may perform operations of multiplexing RLC PDUs to MAC PDUs and demultiplexing RLC PDUs from MAC PDUs. The MACs 230 and 260 may also provide a mapping function, a scheduling information reporting function, a hybrid ARQ (HARQ) function, a function of priority handling between logical channels, a function of priority handling between terminals, a multimedia broadcast/multicast service (MBMS) service identification function, a transmission format selection function, and a padding function. Of course, the above examples are not limited.

Physical (PHY) layers 240 and 250 may perform operations of channel coding and modulating higher layer data, forming the higher layer data into an OFDM symbol, transmitting the OFDM symbol through a radio channel, or of demodulating an OFDM symbol received through a radio channel, channel-decoding the OFDM symbol, and transferring the OFDM symbol to a higher layer. In addition, the physical layer also uses a HARQ for additional error correction, and a receiving node may transmit, as one bit, information relating to whether a packet transmitted by a transmitting node is received. The information is referred to as HARQ acknowledgement (ACK)/negative ACK (NACK) information.

Downlink (DL) HARQ ACK/NACK information for uplink (UL) data transmission is transmitted through a physical hybrid-ARQ indicator channel (PHICH) in case of LTE. In case of NR, whether retransmission is required, and whether to perform new transmission may be determined through scheduling information of a terminal in a physical dedicated control channel (PDCCH) which is a channel through which downlink/uplink resource allocation is transmitted. This is because NR employs asynchronous HARQ. Uplink HARQ ACK/NACK information for downlink data transmission may be transmitted through a physical uplink control channel (PUCCH) or a physical uplink shared channel (PUSCH). The PUCCH is transmitted in the uplink in a primary cell (PCell), which is described later. However, when there is support by a terminal, a base station may additionally transmit the PUCCH to the terminal even in a secondary cell (SCell), which is described later, and the SCell in this case is called a PUCCH SCell.

Although not illustrated in FIG. 2, radio resource control (RRC) layers exist above the PDCP layers of the terminal and the base station, respectively, and the RRC layers may transmit and receive an access/measurement-related configuration control message to perform wireless resource control.

On the other hand, the PHY layer may be configured by one or multiple frequencies/carriers, and a technology in which one base station configures multiple frequencies at once and then uses the multiple frequencies is called carrier aggregation (CA) technology. According to CA technology, in communication between a terminal (or user equipment (UE)) and a base station (an eNB or a gNB) performed using a single carrier, a primary carrier and one or more secondary carriers are additionally used, and thus the transmission volume can be increased by the number of the secondary carriers. In LTE/NR, a cell in a base station that uses a primary carrier is called a primary cell or PCell, and a cell in a base station that uses a secondary carrier is called a secondary cell or SCell.

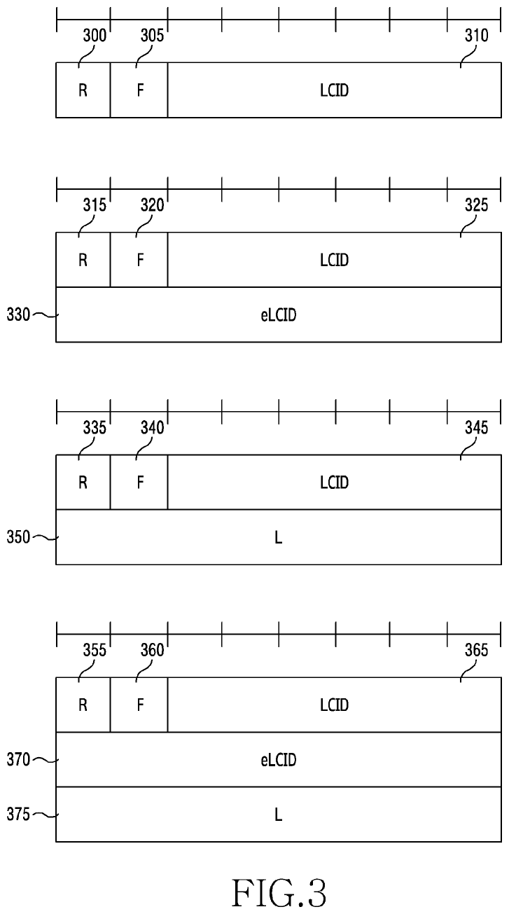

FIG. 3 illustrates the format of a MAC subheader defined in an NR system according to an embodiment of the disclosure.

Referring to FIG. 3, a 1-byte MAC subheader including an R field 300, an F field 305, and a logical channel identifier (LCID) field 310 may be attached before a fixed-length MAC CE. In this case, the MAC CE may be represented by the LCID 310. In addition, according to an embodiment, a 2-byte MAC subheader including an R field 315, an F field 320, an LCID field 325, and extended LCID (eLCID) field 330 may be attached before the fixed-length MAC CE. In this case, the presence and length of the eLCID field 330 may be represented by the LCID field 325, and the MAC CE may be represented by the eLCID field 330.

In addition, according to an embodiment, a 2-byte MAC subheader including an R field 335, an F field 340, an LCID field 345, and an L field 350 may be attached before a variable-length MAC CE. The F field 340 may represent whether the L field 350 has a length of 1-byte or 2-byte, and the MAC CE may be represented by the LCID field 345. According to an embodiment, a 3-byte MAC subheader including an R field 355, an F field 360, an LCID field 365, an eLCID field 370, and an L field 375 may be attached before a variable-length MAC CE. In this case, an F field 360 may represent whether the length of the L field 375 is 1-byte or 2-byte, the LCID field 365 may represent the presence and length of the eLCID field 370, and the eLCID field 370 may represent the MAC CE. Short BSR/short truncated BSR/long BSR/long truncated BSR have different LCID values of the MAC subheader attached before them, and thus the base station receiving them may distinguish the format of the received BSR. Extended short BSR/extended long BSR/extended short truncated BSR/extended long truncated BSR have different eLCID values of the MAC subheader attached before them, and thus the base station receiving them may distinguish the format of the received BSR.

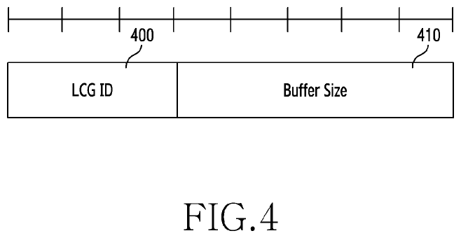

FIG. 4 illustrates a short BSR/short truncated BSR MAC CE format defined in an NR system according to an embodiment of the disclosure.

Referring to FIG. 4, the short BSR MAC CE may include a 3-bit LCG ID field 400 and a 5-bit buffer size field 410. The LCG ID field 400 represents IDs (0 to 7) of the LCG, and the buffer size (BS) field 410 field represents a buffer size (BS) index determined by an uplink buffer size corresponding to the LCG ID field 400. The BS index has a value between 0 and 31. The BS index may represent the index of a corresponding interval that includes the uplink buffer size corresponding to the LCG ID field 400 in a buffer size interval defined in a pre-defined buffer size table for the 5-bit BS field.

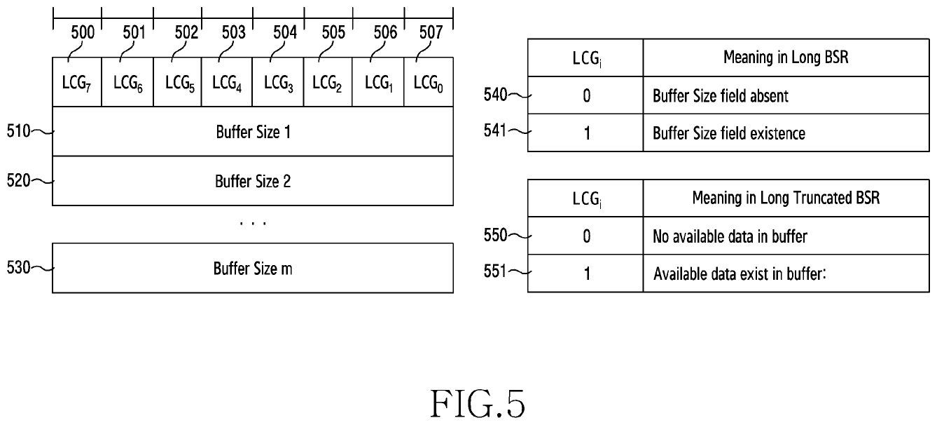

FIG. 5 illustrates a long BSR/long truncated BSR MAC CE format defined in an NR system according to an embodiment of the disclosure.

Referring to FIG. 5, the long BSR MAC CE may represent the presence or absence of a buffer size field corresponding to each of the eight LCGs from LCG₇-ID 500 to LCG₀ ID 507, by using eight bits of the first byte. A bit value of “0” 540 may signify that a buffer size field of an LCG corresponding to a bit of the long BSR MAC CE does not exist. On the contrary, a bit value of “1” 541 may signify that a buffer size field of an LCG corresponding to a bit of the long BSR MAC CE exists.

Accordingly, there may be as many buffer size fields in the long BSR MAC CE as there are the number of bits with a value of 1 in the first byte. The length of the buffer size fields 510, 520, and 530 of the long BSR MAC CE may be 8 bits. The long truncated BSR MAC CE may use the eight bits of the first byte to represent whether the uplink buffer size for each of the eight LCGs, from LCG₇ ID 500 to LCG₀ ID 507, is greater than zero (i.e., whether there is available uplink data). A bit value of “0” 550 may signify that the corresponding LCG has no available uplink data, and a bit value “1” 551 may signify that the corresponding LCG has available uplink data.

In a long truncated BSR MAC CE, the number of buffer size fields 510, 520, and 530 may be represented by the L field 350 or 375 of the MAC subheader that is attached before the MAC CE, and the buffer size (BS) fields 510, 520, and 530 adds the remaining uplink resources to the MAC CE in descending order by considering a priority of the LCG having available data. The buffer size field of a long BSR or long truncated BSR may also represent a BS index, which is determined by the uplink buffer size, similarly to the buffer size field of the short BSR.

The NR system has defined a buffer size table for the 8-bit BS field for long BSR/long truncated BSR, and may display the index of the buffer size interval including the uplink buffer size by the BS field. While the BS field 410 of a short BSR has a 5-bit length, the BS field of a long BSR or long truncated BSR has a 8-bit length. Accordingly, the buffer size table referenced by the long BSR defines a total of 255 BS indices from 0 to 254, and “255” is reserved and not in use. After receiving the BS index, the base station may refer to the buffer size table for the long BSR to obtain information about the uplink buffer size for each LCG.

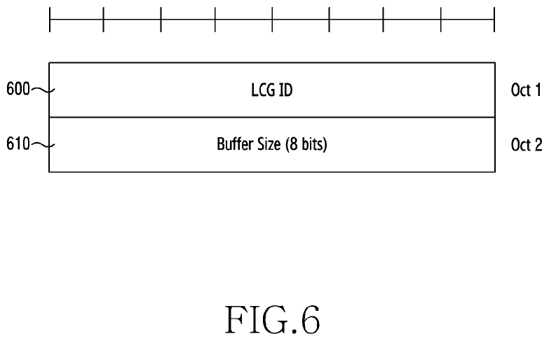

FIG. 6 illustrates an extended short BSR/extended short truncated BSR MAC CE format defined in an NR system according to an embodiment of the disclosure.

Referring to FIG. 6, the extended short BSR/extended short truncated BSR may include an 8-bit LCG ID field 600 and an 8-bit BS field 610. The LCG ID field 600 represents an ID (0 to 255) of the LCG, and the BS 610 field represents a BS index determined by the uplink buffer size corresponding to the LCG ID 600. The BS index may represent the index of a corresponding interval that includes the uplink buffer size corresponding to the LCG ID field 600 in a buffer size interval defined in a pre-defined buffer size table for the 8-bit BS field.

Long BSR/long truncated BSR/Short BSR/short truncated BSR/extended short BSR/extended short truncated BSR defined in the NR system has the following characteristics. They are not limited to the following examples.
The BS index represented by the BS field of the MAC CE may correspond to a specific buffer size interval in a predefined table instead of corresponding to a specific buffer size.
The size of the buffer size interval may increase as the BS index value increases, i.e., as the buffer size increases.

Accordingly, the larger the uplink buffer size, the more likely that a terminal transmits a BS index corresponding to a larger buffer size interval, and the base station receiving the BS index may have difficulty predicting the exact buffer size, thus making efficient uplink resource allocation difficult.

In the disclosure, the BS tables for the existing 5-bit BS field and the 8-bit BS field described above are referred to as the existing BS table. For example, according to an embodiment, in addition to the existing BS tables, a new BS table (NBT) is introduced and thus a terminal may report a buffer size interval in more detail by referring to the NBT when reporting buffer sizes to the base station. The NBT proposed in the disclosure may be a predefined fixed table. Of course, this is not limited to the above example. In addition, the NBT proposed herein may also be dynamically configured or changed by the base station transferring NBT-related parameters to the terminal through RRC messages or MAC CEs. Of course, this is not limited to the above examples, and NBT-related parameters may be transferred via other types of messages.

The NBT-related parameter may be one or more of the following parameters, such as a minimum buffer size (Bmin), a maximum buffer size (Bmax), a BS interval size, the number of BS intervals, a method of dividing the BS intervals (e.g., uniform or exponential), etc. According to an embodiment of the disclosure, if an NBT has a BS index number of 2L, the NBT may be referred to as an NBT for L-bit BS fields.

According to an embodiment of the disclosure, when a BSR that a terminal transmits to a base station includes at least one BS field that is reported with reference to an NBT, the BSR may be referred to as an NBT BSR.

According to an embodiment of the disclosure, NBT BSRs may be categorized as follows.
NBT short BSR: The NBT short BSR may report the uplink buffer size for a specific LCG or logical channel (LCH) by including only one BS field. For example, the NBT short BSR may indicate the presence of a BS field corresponding to the LCG or LCH, by including an indicator indicating the ID of the LCG or LCH for reporting the uplink buffer size. The LCG or LCH indicator may be configured by directly indicating a value of the ID of the corresponding LCG or LCH in a binary format, or by indicating a bit in the corresponding location of the bitmap as “1”. For example, the BS field length of the NBT short BSR may be one of 5 bits, 8 bits, 13 bits, 15 bits, or 16 bits. In an example, the BS field length of the NBT short BSR may be greater than 16 bits. In an example, the NBT short BSR may include a reserved field for byte alignment. In an example, the NBT short BSR may include a table indicator to indicate which BS table is being referenced by the BS field of the LCG or LCH being reported. For example, the candidate BS table may include an existing BS table and one or more NBTs.
NBT long BSR: The NBT long BSR may report the uplink buffer size for one or more LCGs or LCHs by configuring a BS field for each LCG or LCH. For example, the NBT long BSR may include a bitmap field, in which the NBT long BSR may configure, as a specific value, a bit in a position corresponding to the LCG or LCH to be reported, and may indicate that the BS field for the LCG or LCH exists in the NBT long BSR. For example, the NBT long BSR may include a table indicator that indicates which BS table the corresponding BS field is referring to, for each LCG or LCH being reported. For example, the table indicator may exist only for LCGs or LCHs for which the base station has previously established a specific feature (e.g., may be referred to as XR-Ext) with a predetermined RRC message or MAC CE. For example, the candidates for the BS table may include an existing BS table and one or more NBTs. In an example, the length of the BS field may be one of 8 bits, 15 bits, and 16 bits. In an example, the length of the BS field may be greater than 16 bits. In an example, the NBT long BSR may include a reserved field for byte alignment.

According to an embodiment of the disclosure, when a terminal reports an uplink buffer size through an NBT BSR to a base station,
For example, all of BS fields included in the corresponding NBT BSR may be configured by referring to the NBT.
For example, LCG configured with XR-Ext, in BS fields included in the corresponding NBT BSR may be configured by referring to the NBT.
For example, LCG configured with XR-Ext, in BS fields included in the corresponding NBT BSR may be configured by referring to the existing BS table.
For example, for each LCG configured with XR-Ext, in BS fields included in the corresponding NBT BSR, an indicator indicating which BS table the corresponding BS field is referring to and configured may be added to the NBT BSR.

According to an embodiment of the disclosure, the BSRs that a terminal may transmit to a base station may be categorized as follows.
5-bit BS field BSRs (e.g., may be referred to as 5B-BSRs): All BS fields included in a corresponding BSR may be 5 bits in length. For example, this type of BSR may be a short BSR or a short truncated BSR.
More than 5-bit BS field BSR (for example, it may be referred to as an M5B-BSR): All BS fields included in a corresponding BSR may be longer than 5-bit in length. For example, a BSR of this type may be one of long BSR, long truncated BSR, extended short BSR, NBT short BSR, and NBT long BSR. For example, the BSR may be referred to as an M5B-BSR when the length of all BS fields included in addition to the above BSR is greater than 5 bits.

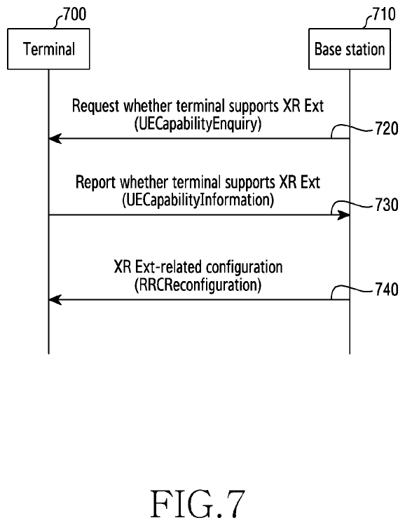

FIG. 7 illustrates a signaling procedure performed by a terminal and a base station according to an embodiment of the disclosure.

Referring to FIG. 7, a base station 710 may deliver, to a terminal 700 which is in a connected state, a UE capability request message (UECapabilityEnquiry) 720 requesting a capability report. The base station may include a radio access technology (RAT) type-specific UE capability request in the UECapabilityEnquiry message 720. The RAT type-specific request may include frequency band information to be requested.

In addition, when the base station requests the terminal 700 to generate a UECapabilityInformation message 730 through the UECapabilityEnquiry message 720, the base station may include, in the message, filtering information that may indicate conditions and restrictions. The filtering information may allow the base station 710 to indicate whether the terminal 700 should report whether the terminal supports XR-Ext. The terminal 700 may configure a UE capability information message (UECapabilityInformation) 730 corresponding to the UECapabilityEnquiry message 720 and report a response to the UECapabilityEnquiry message to the base station 710. For example, the UECapabilityInformation message 730 may include a parameter indicating whether the terminal supports XR-Ext. For example, the parameter may be 1-bit information. Further, for example, the inclusion of the parameter may indicate that XR-Ext is supported, and the absence of the parameter may indicate that XR-Ext is not supported. For example, the UECapabilityInformation message 730 may include an indicator indicating which of the above BSR formats the terminal supports.

The base station 710 may determine that the terminal 700 supports XR-Ext based on the received UECapabilityInformation message 730. The base station 710 may determine which BSR format the terminal 700 supports, based on the received UECapabilityInformation message 730. When the base station 710 determines that the terminal 700 supports XR-Ext, the base station 710 may instruct XR-Ext-related configurations via a predetermined RRC message (e.g., RRCReconfiguration message 740).

More specifically, the XR-Ext-related configuration may include at least one of the following configuration information. Of course, the configuration is not limited to the following examples.
XR-Ext may be configured for one or more LCHs or one or more LCGs of a corresponding terminal, one or more MAC entities, or the corresponding terminal.
For one or more LCHs or one or more LCGs of a corresponding terminal, one or more MAC entities, or the corresponding terminal, when only the corresponding LCG or LCH has available data and other LCG or LCH has no available data, the XR-Ext-related configuration may indicate which M5B-BSR format should be used.
The XR-Ext-related configuration may include a table indicator to be referenced when configuring a BS field for each LCH, LCG, MAC entity or a UE.
The XR-Ext-related configuration may include Bmin, which is the smallest non-zero value of the upper or lower limit for each index of the NBT.
The XR-Ext-related configuration may include Bmax, which is the largest non-zero value of the upper or lower limit for each index of the NBT.
The XR-Ext-related configuration may include the number of indices of the NBT, or L when the number of indices is represented by 2L.
The XR-Ext-related configuration may include the BS interval size when the BS intervals of the NBT have the same size.
The XR-Ext-related configuration may include an indicator indicating a method for dividing the BS interval of the NBT (e.g., uniform or exponential).

According to an embodiment of the disclosure, a reserved value of the LCID codepoint used by the NR system may be assigned to indicate NBT short BSR, NBT long BSR, and extended short BSR, respectively.

According to an embodiment of the disclosure, a reserved value of the eLCID codepoint used by the NR system may be assigned to indicate NBT short BSR, NBT long BSR, and extended short BSR, respectively.

According to an embodiment of the disclosure, when the base station establishes XR-Ext for one or more LCGs or one or more LCHs of the terminal through an RRC message, the terminal may operate as follows.
For example, when XR-Ext is configured for a specific LCH, the terminal may assume that XR-Ext is also configured for an LCG to which the corresponding LCH belongs.
In a specific MAC entity, for regular and periodic BSRs, the terminal may operate as follows.
When the MAC PDU including the corresponding BSR is built, if two or more LCGs have available uplink data,
   When there is no LCG with XR-Ext configured among the LCGs having the available data:
      Long BSR may be applied to report the uplink buffer size for all LCGs having the available data.
   When there is at least one LCG with XR-Ext configured among the LCGs having the available data:
      The NBT long BSR may be applied to report the uplink buffer size for all LCGs having the available data.
If one LCG has available uplink data when the MAC PDU including the corresponding BSR is built,
   If the LCG has XR-Ext configured:
      M5B-BSR may be applied to report the uplink buffer size for the LCG.
      For example, when there is available uplink data only for the corresponding LCG, if the base station has configured, for a terminal through RRC, which BSR format should be applied, the terminal may apply the corresponding BSR format.
   If the LCG is not configured with XR-Ext:
      5B-BSR may be applied to report the uplink buffer size for the LCG.
If no LCG having available uplink data exists when the MAC PDU including the corresponding BSR is built:
   5B-BSR may be applied to report that there is no data available in the uplink buffer.

According to an embodiment of the disclosure, if the base station has configured XR-Ext for one or more MAC entities of the terminal through an RRC message, the terminal may operate as follows.
For example, when XR-Ext is configured for a specific LCH or LCG, the terminal may assume that XR-Ext is also configured for the MAC entity to which the LCH or LCG belongs.
In a specific MAC entity, for regular and periodic BSRs, the terminal may operate as follows.
When there is available uplink data in two or more LCGs when the MAC PDU including the corresponding BSR is built,
   XR-Ext is not configured for the corresponding MAC entity:
      Long BSR may be applied to report the uplink buffer size for all LCGs having the available data.
   When XR-Ext is configured for the corresponding MAC entity:
      NBT long BSR may be applied to report the uplink buffer size for all LCGs having the available data.
When there is available uplink data in one LCG when the MAC PDU including the corresponding BSR is built,
   When XR-Ext is configured for the corresponding MAC entity:
      M5B-BSR may be applied to report the uplink buffer size for the LCG.
      For example, when a base station has configured, for a terminal via RRC, which BSR format should be applied when there may be only uplink data available for the corresponding LCG, the terminal may apply the corresponding BSR format.
   When XR-Ext is not configured for the corresponding MAC entity:
      5B-BSR may be applied to report the uplink buffer size for the LCG.
If there is no LCG having available uplink data when the MAC PDU including the corresponding BSR is built:
   5B-BSR may be applied to report that there is no data available in the uplink buffer.

According to an embodiment of the disclosure, if the base station has configured XR-Ext for one or more LCHs of the terminal through an RRC message, the terminal may operate as follows.
In a specific MAC entity, for regular and periodic BSRs, the terminal may operate as follows.
When there is available uplink data in two or more LCGs when the MAC PDU including the corresponding BSR is built,
   When there is no LCH for which XR-Ext is configured among LCHs having available uplink data:
      Long BSR may be applied to report the uplink buffer size for all LCGs having the available data.
   When there is at least one LCH for which XR-Ext is configured among LCHs having available uplink data:
      The NBT long BSR may be applied to report the uplink buffer size for all LCGs having the available data.
When there is one LCG having available uplink data when the MAC PDU including the corresponding BSR is built,
   When there is at least one LCH for which XR-Ext is configured among LCHs having available uplink data:
      M5B-BSR may be applied to report the uplink buffer size for the LCG.
      For example, the base station has configured for a terminal through RRC which BSR format should be applied when there may be available uplink data only for the corresponding LCG, the terminal may apply the corresponding BSR format.
   When there is no LCH for which XR-Ext is configured among LCHs having available uplink data:
      5B-BSR may be applied to report the uplink buffer size for the LCG.
If there is no LCG having available uplink data when the MAC PDU including the corresponding BSR is built:
   5B-BSR may be applied to report that there is no data available in the uplink buffer.

According to an embodiment of the disclosure, if the base station has configured XR-Ext for one or more configured grants (CGs) of the terminal through an RRC message, the terminal may operate as follows
In a specific MAC entity, for regular and periodic BSRs, the terminal may operate as follows.
When there is available uplink data in two or more LCGs when the MAC PDU including the corresponding BSR is built,
   UL grant to which the MAC PDU is to be sent is not a CG for which XR-Ext is configured:
      Long BSR may be applied to report the uplink buffer size for all LCGs having the available data.
   When UL grant to which the corresponding MAC PDU is to be sent is a CG for which XR-Ext is configured:
      The NBT long BSR may be applied to report the uplink buffer size for all LCGs having the available data.
When there is available uplink data in one LCG when the MAC PDU including the corresponding BSR is built,
   When UL grant to which the MAC PDU is to be sent is a CG for which XR-Ext is configured:
      M5B-BSR may be applied to report the uplink buffer size for the LCG.
      For example, if the base station has configured for a terminal through RRC which BSR format should be applied, when the terminal may have available uplink data only for the corresponding LCG, the terminal may apply that BSR format.
   When UL grant to which the MAC PDU is to be sent is not a CG for which XR-Ext is configured:
      5B-BSR may be applied to report the uplink buffer size for the LCG.
If there is no LCG having available uplink data when the MAC PDU including the corresponding BSR is built:
   5B-BSR may be applied to report that there is no data available in the uplink buffer.

According to an embodiment of the disclosure, when a base station is able to configure XR-Ext for a specific terminal, the terminal may operate as follows.
In a specific MAC entity, for regular and periodic BSRs, the terminal may operate as follows.
When there is available uplink data in two or more LCGs when the MAC PDU including the corresponding BSR is built,
   When the terminal is not configured with XR-Ext:
      Long BSR may be applied to report the uplink buffer size for all LCGs having the available data.
   When the terminal is configured with XR-Ext:
      NBT long BSR may be applied to report the uplink buffer size for all LCGs having the available data.
If there is available uplink data in one LCG when the MAC PDU including the corresponding BSR is built,
   When the terminal is configured with XR-Ext
      The M5B-BSR may be applied to report the uplink buffer size for the LCG.
      For example, if the base station has configured for a terminal through RRC which BSR format should be applied when the terminal may have available uplink data only for the corresponding LCG, the terminal may apply the corresponding BSR format.
   When the terminal is not configured with XR-Ext:
      5B-BSR may be applied to report the uplink buffer size for the LCG.
When the MAC PDU including the corresponding BSR is built, no LCG having available uplink data exists:
   5B-BSR may be applied to report that there is no data available in the uplink buffer.

According to an embodiment of the disclosure, when, for a padding BSR in a specific MAC entity, the length of a padding bit is at least 3 bytes, the terminal may apply M5B-BSR to transmit the padding BSR. For example, the MAC subheader of the M5B-BSR transmitted through the padding BSR may indicate the format of the corresponding BSR in the LCID field. In an example, the M5B-BSR transmitted through the padding BSR may be an extended short BSR.

According to an embodiment of the disclosure, when an LCG corresponding to a BS field included in the M5B-BSR is configured to be able to refer to an NBT, the terminal may configure the corresponding BS field by referring to the NBT. According to an embodiment of the disclosure, when the LCG corresponding to a BS field included in the M5B-BSR is configured not to be able to refer to an NBT, the terminal may configure the corresponding BS field by referring to an existing BS table.

According to an embodiment of the disclosure, the terminal may report to the base station a remaining time (RT) of data stored in the uplink buffer to assist resource efficient uplink scheduling of the base station. For example, the RT of a specific uplink data may indicate that after the corresponding time has elapsed, it is no longer meaningful to transmit the corresponding uplink data to the base station. For example, the RT of a specific uplink data may indicate that the data should be delivered to the base station before the corresponding time has elapsed.

According to an embodiment of the disclosure, the terminal may report to the base station by adding, to a delay report MAC CE, one or more fields that correspond to a possible combination of one or more pieces of information and one or more conditions among pieces of information or conditions described below. For example, the delay report MAC CE may be a form obtained by adding fields corresponding to the above-described BSR format (e.g., 5B-BSR, M5B-BSR), or a form obtained by adding fields corresponding to a newly defined separate MAC CE.
An RT field indicating a corresponding RT may be included for each LCG. There may be one or multiple RT fields corresponding to a specific LCG.
An RT field indicating a corresponding RT may be included for each LCH. There may be one or multiple RT fields corresponding to a specific LCH.
When an RT field corresponds to a specific LCG or LCH, the presence of the RT field corresponding to the LCG or LCH may be indicated by including an LCG or LCH indicator corresponding to the RT field. The LCG or LCH indicator may represent the ID of the LCG or LCH by using a specific position bit of the bitmap or directly as a binary value.
When the base station has preconfigured a corresponding function for one or more LCGs or one or more LCHs through a predetermined RRC message (e.g., RRCReconfiguration), only the LCGs or LCHs for which the corresponding function has been configured may include the corresponding RT field or have an RT attribute. For example, when the above configuration is configured for a specific LCH, the LCG to which the LCH belongs may also be considered to have the function configured.
When the base station has preconfigured an RT threshold for each UE, each MAC entity, each LCG, or each LCH through a predetermined RRC message (e.g., RRCReconfiguration), only an LCG or LCH that has an RT belonging in an allowable range indicated by the RT threshold, a PDU set buffered on the LCH, a data bursts buffered on the LCH, or a PDU buffered on the LCH may include a corresponding RT field or have an RT attribute. For example, if the RT threshold indicates a single specific RT value, the allowable range may be an RT interval equal to or less, or equal to or greater than an indicated value. For example, when the RT threshold includes both an upper bound and a lower bound, the allowable range may be an RT interval that is equal to or greater than the corresponding lower bound and equal to or less than the upper bound.
In case that one RT field is configured for each LCG:
   The corresponding RT field may be configured based on the smallest RT among RTs corresponding to LCHs having an RT attribute and belonging to LCGs.
   The corresponding RT field may be configured based on the average value of RTs corresponding to LCHs having an RT attribute and belonging to LCGs.
   The corresponding RT field may be configured using an RT corresponding to a representative LCH configured by a base station, among LCHs belonging in LCGs.
In case that one or more RT fields are configured for each LCG:
   A corresponding RT field may be added to each LCH having an RT attribute and belonging to LCGs, and the RT field may be configured based on an RT corresponding to each LCH.
   For each LCH having an RT attribute and belonging to LCGs, a corresponding RT field may be added only to an RT attribute belonging to an allowable RT range indicated by a base station, and the RT field may be configured based on the corresponding RT.
In case that data buffered in a specific LCH is configured in a data unit including multiple RTs:
   RT corresponding to the LCH may be determined as the smallest RT of multiple RTs in a data unit.
   Multiple RT fields corresponding to the LCH may indicate multiple RTs in a data unit, respectively. For example, the RT field may exist only for an RT that falls within the allowable RT range indicated by the base station.
   A single RT field corresponding to the LCH may indicate an RT corresponding to the LCH. For example, this RT field may exist as long as the base station belongs within the allowable RT range preconfigured by the base station.
In an example, among the data buffered in the LCH, the data unit for a particular RT may be a PDU, a PDU set, or a data burst.
In an example, when there is an RT field, a buffer size field may be added corresponding to the RT indicated by the RT field. In an example, one or more buffer size fields may exist for each LCH or LCG. In an example, one or more buffer size fields may exist for each RT field.
In an example, a buffer size field may be added for each LCH or LCG. For example, the inclusion of an LCH or LCG indicator corresponding to the buffer size field may indicate the presence of a buffer size field corresponding to the LCH or LCG. The LCH or LCG indicator may indicate the ID of the LCH or LCG through a bit at a specific location in a bitmap or directly as a binary value. For example, the LCH or LCG-specific buffer size field may be added only to LCHs or LCGs having an RT attribute.

According to an embodiment of the disclosure, in connection with configuring the RT field included when configuring a delay report MAC CE, the RT of a specific data unit may be determined by one of the following examples.
A delay budget (DB) remaining with reference to a time point at which the delay report MAC CE is configured
A DB remaining with reference to a time point at which initial transmission of the MAC PDU including the delay report MAC CE occurs
A DB remaining with reference to a time point at which a UL grant required to transmit the MAC PDU including the MAC CE is received

According to an embodiment of the disclosure, the DB may refer to one of a PDU-set delay budget (PSDB), a 5G access network PSDB (5G-AN PSDB), a packet delay budget (PDB), or PDCP discardTimer time of the corresponding data unit. However, the disclosure is not limited to the above examples.

According to an embodiment of the disclosure, the RT field of the delay report MAC CE may indicate an index to which the RT belongs by referring to an RT Table including a predefined index for each RT interval.

According to an embodiment of the disclosure, the RT field of the delay report MAC CE may indicate an RT by using an absolute value in a specific unit or a preconfigured reference time-based relative value in a specific unit. For example, the specific units may be represented by one of milliseconds, microseconds, symbols, slots, subframes, and frames, or a combination of one or more thereof.

According to an embodiment of the disclosure, trigger conditions of the delay report MAC CE may include at least one of the following conditions.
UL data, for a logical channel which belongs to an LCG, becomes available to the MAC entity; and either this UL data belongs to a logical channel with higher priority than the priority of any logical channel including available UL data which belong to any LCG; or none of the logical channels which belong to an LCG contains any available UL data.
UL resources are allocated, and number of padding bits is equal to or larger than the size of the delay report MAC CE plus its subheader
periodicDelayReportTimer expires
When new uplink data occurs, the delay report MAC CE may be triggered if the LCH or LCG to which the uplink data belongs has the RT attribute and the RT of the uplink data is equal to or less than a specific threshold configured by the base station through a predetermined RRC message.
When new uplink data occurs, the delay report MAC CE may be triggered if the LCH or LCG to which the uplink data belongs has the RT attribute and uplink data with RT, which is equal to or less than a specific threshold reconfigured by the base station through a predetermined RRC message, exists in the LCH or LCG to which the uplink data belongs.
When there is new uplink data with an RT equal to or less than a specific threshold predefined by the base station in the uplink buffer of the LCG or LCH with the RT attribute, or when the RT of existing data becomes equal to or less than the threshold, the delay report MAC CE may be triggered.

According to an embodiment of the disclosure, the periodicDelayReportTimer may be a timer having the same value as that of the periodicBSR-Timer configured in BSR-Config. For example, the periodicDelayReportTimer may be configured to add a new field (e.g., periodicDelayReportTimer) to the existing BSR-Config and allow, based on the new field, the periodicDelayReportTimer to have a different value from that of the existing periodicBSR-Timer.

According to an embodiment of the disclosure, a refined long BSR and NBT long BSR may refer to the same BSR MAC CE format.

According to an embodiment of the disclosure, a refined long BSR and NBT short BSR may refer to the same BSR MAC CE format.

According to an embodiment of the disclosure, a refined long BSR may include both an NBT short BSR and an NBT long BSR.

According to an embodiment of the disclosure, in a process of selecting a format for a corresponding BSR when a MAC layer device of a terminal transmits a BSR MAC CE by including the same in a specific MAC PDU, the following embodiments may exist in connection with a time point of determining whether data exists in a buffer of a specific LCG and/or a time point of determining a buffer size of a specific LCG.
Time 1: this may refer to a state before performing, for a corresponding MAC PDU, a logical channel prioritization process when the MAC PDU including the BSR is to be built (i.e., a state in which an amount of data to be transmitted for each logical channel is not determined). Determination of the LCG state at the corresponding time point may reduce the implementation complexity of the terminal.
Time 2: this may refer to a state in which, when the MAC PDU including the BSR has been built, a logical channel prioritization process for the MAC PDU has been completed (the amount of data to be transmitted for each logical channel has been determined). The buffer size for each LCG reported in the BSR may refer to the amount of data still remaining in the buffer for each LCG after transmitting the corresponding MAC PDU, and thus the MAC layer device may select the most appropriate BSR format for BSR reporting.
Time 3: this may refer to a time point at which a BSR MAC CE is configured when the BSR is to be built. For example, the time point may be Time 1 or Time 2, or some other time points, depending on the terminal implementation. Accordingly, this may signify that the appropriate time point is determined by the implementation of the terminal. For example, in case of a padding BSR, this time point may refer to a time point of generating the padding BSR.

According to an embodiment of the disclosure, the NBT of the disclosure may refer to Table 6.1.3.1-3 of TS 38.321 standard. In an example, the table may be a table defining refined buffer size levels (in bytes) for 8-bit buffer size field.

According to an embodiment of the disclosure, a MAC layer device, for which logicalChannelGroupIAB-Ext is not configured by a higher layer, may operate for regular and periodic BSRs as follows.
1> if for at least one LCG configured with additionalBSR-TableAllowed (or, additionalBS-TableAllowed), the amount of UL data available for transmission at Time 1 is within the buffer sizes specified in Table 6.1.3.1-3 of TS 38.321:
2> report Refined Long BSR for all LCGs which have data available for transmission;
1> else:
2> if more than one LCG has data available for transmission at Time 1:
   3> report Long BSR for all LCGs which have data available for transmission.
2> else if one LCG has data available and is configured with additionalBS-TableAllowed and the amount of UL data available for transmission at Time 1 is greater than the largest buffer size specified in Table 6.1.3.1-3:
   3> report Long BSR;
2> else:
   3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 1 is within the buffer sizes specified in Table 6.1.3.1-3 of TS 38.321:
   2> report Refined Long BSR for all LCGs which have data available for transmission;
1> else:
   2> if more than one LCG has data available for transmission at Time 1:
      3> report Long BSR for all LCGs which have data available for transmission.
   2> else if one LCG has data available and is configured with additionalBS-TableAllowed and the amount of UL data available for transmission at Time 2 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to
1> if for at least one LCG configured with additionalBSR-TableAllowed (or, additionalBS-TableAllowed), the amount of UL data available for transmission at Time 1 is within the buffer sizes specified in Table 6.1.3.1-3 of TS 38.321:
   2> report Refined Long BSR for all LCGs which have data available for transmission;
1> else:
   2> if more than one LCG has data available for transmission at Time 1:
      3> report Long BSR for all LCGs which have data available for transmission.
   2> else if one LCG has data available and is configured with additionalBS-TableAllowed and the amount of UL data available for transmission at Time 3 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 1 is within the buffer sizes specified in Table 6.1.3.1-3 of TS 38.321:
   2> report Refined Long BSR for all LCGs which have data available for transmission.
1> else:
   2> if more than one LCG has data available for transmission at Time 2:
      3> report Long BSR for all LCGs which have data available for transmission.
   2> else if one LCG has data available and is configured with additionalBS-TableAllowed and the amount of UL data available for transmission at Time 1 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 1 is within the buffer sizes specified in Table 6.1.3.1-3 of TS 38.321:
   2> report Refined Long BSR for all LCGs which have data available for transmission;
1> else:
   2> if more than one LCG has data available for transmission at Time 2:
      3> report Long BSR for all LCGs which have data available for transmission.
   2> else if one LCG has data available and is configured with additionalBS-TableAllowed and the amount of UL data available for transmission at Time 2 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 1 is within the buffer sizes specified in Table 6.1.3.1-3 of TS 38.321:
   2> report Refined Long BSR for all LCGs which have data available for transmission;
1> else:
   2> if more than one LCG has data available for transmission at Time 2;
      3> report Long BSR for all LCGs which have data available for transmission.
   2> else if one LCG has data available and is configured with additionalBS-TableAllowed and the amount of UL data available for transmission at Time 3 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 1 is within the buffer sizes specified in Table 6.1.3.1-3 of TS 38.321:
   2> report Refined Long BSR for all LCGs which have data available for transmission;
1> else:
2> if more than one LCG has data available for transmission at Time 3:
   3> report Long BSR for all LCGs which have data available for transmission.
   2> else if one LCG has data available and is configured with additionalBS-TableAllowed and the amount of UL data available for transmission at Time 1 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 1 is within the buffer sizes specified in Table 6.1.3.1-3 of TS 38.321:
   2> report Refined Long BSR for all LCGs which have data available for transmission;
1> else:
   2> if more than one LCG has data available for transmission at Time 3:
      3> report Long BSR for all LCGs which have data available for transmission.
   2> else if one LCG has data available and is configured with additionalBS-TableAllowed and the amount of UL data available for transmission at Time 2 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 1 is within the buffer sizes specified in Table 6.1.3.1-3 of TS 38.321:
   2> report Refined Long BSR for all LCGs which have data available for transmission.
1> else:
   2> if more than one LCG has data available for transmission at Time 3:
      3> report Long BSR for all LCGs which have data available for transmission.
   2> else if one LCG has data available and is configured with additionalBS-TableAllowed and the amount of UL data available for transmission at Time 3 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 2 is within the buffer sizes specified in Table 6.1.3.1-3 of TS 38.321:
   2> report Refined Long BSR for all LCGs which have data available for transmission;
1> else:
   2> if more than one LCG has data available for transmission at Time 1:
      3> report Long BSR for all LCGs which have data available for transmission.
   2> else if one LCG has data available and is configured with additionalBS-TableAllowed and the amount of UL data available for transmission at Time 1 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 2 is within the buffer sizes specified in Table 6.1.3.1-3 of TS 38.321:
   2> report Refined Long BSR for all LCGs which have data available for transmission;
1> else:
   2> if more than one LCG has data available for transmission at Time 1:
      3> report Long BSR for all LCGs which have data available for transmission.
   2> else if one LCG has data available and is configured with additionalBS-TableAllowed and the amount of UL data available for transmission at Time 2 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 2 is within the buffer sizes specified in Table 6.1.3.1-3 of TS 38.321:
   2> report Refined Long BSR for all LCGs which have data available for transmission;
1> else:
   2> if more than one LCG has data available for transmission at Time 1:
      3> report Long BSR for all LCGs which have data available for transmission.
   2> else if one LCG has data available and is configured with additionalBS-TableAllowed and the amount of UL data available for transmission at Time 3 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 2 is within the buffer sizes specified in Table 6.1.3.1-3 of TS 38.321:
   2> report Refined Long BSR for all LCGs which have data available for transmission;
1> else:
   2> if more than one LCG has data available for transmission at Time 2:
      3> report Long BSR for all LCGs which have data available for transmission.
   2> else if one LCG has data available and is configured with additionalBS-TableAllowed and the amount of UL data available for transmission at Time 1 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 2 is within the buffer sizes specified in Table 6.1.3.1-3 of TS 38.321:
   2> report Refined Long BSR for all LCGs which have data available for transmission.
1> else:
   2> if more than one LCG has data available for transmission at Time 2;
      3> report Long BSR for all LCGs which have data available for transmission.
   2> else if one LCG has data available and is configured with additionalBS-TableAllowed and the amount of UL data available for transmission at Time 2 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 2 is within the buffer sizes specified in Table 6.1.3.1-3 of TS 38.321:
   2> report Refined Long BSR for all LCGs which have data available for transmission;
1> else:
   2> if more than one LCG has data available for transmission at Time 2:
      3> report Long BSR for all LCGs which have data available for transmission.
   2> else if one LCG has data available and is configured with additionalBS-TableAllowed and the amount of UL data available for transmission at Time 3 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 2 is within the buffer sizes specified in Table 6.1.3.1-3 of TS 38.321:
   2> report Refined Long BSR for all LCGs which have data available for transmission;
1> else:
   2> if more than one LCG has data available for transmission at Time 3:
      3> report Long BSR for all LCGs which have data available for transmission.
   2> else if one LCG has data available and is configured with additionalBS-TableAllowed and the amount of UL data available for transmission at Time 1 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 2 is within the buffer sizes specified in Table 6.1.3.1-3 of TS 38.321:
   2> report Refined Long BSR for all LCGs which have data available for transmission;
1> else:
   2> if more than one LCG has data available for transmission at Time 3:
      3> report Long BSR for all LCGs which have data available for transmission.
   2> else if one LCG has data available and is configured with additionalBS-TableAllowed and the amount of UL data available for transmission at Time 2 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 2 is within the buffer sizes specified in Table 6.1.3.1-3 of TS 38.321:
   2> report Refined Long BSR for all LCGs which have data available for transmission;
1> else:
   2> if more than one LCG has data available for transmission at Time 3:
      3> report Long BSR for all LCGs which have data available for transmission.
   2> else if one LCG has data available and is configured with additionalBS-TableAllowed and the amount of UL data available for transmission at Time 3 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 3 is within the buffer sizes specified in Table 6.1.3.1-3 of TS 38.321:
   2> report Refined Long BSR for all LCGs which have data available for transmission.
1> else:
   2> if more than one LCG has data available for transmission at Time 1:
      3> report Long BSR for all LCGs which have data available for transmission.
   2> else if one LCG has data available and is configured with additionalBS-TableAllowed and the amount of UL data available for transmission at Time 1 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 3 is within the buffer sizes specified in Table 6.1.3.1-3 of TS 38.321:
   2> report Refined Long BSR for all LCGs which have data available for transmission;
1> else:
   2> if more than one LCG has data available for transmission at Time 1:
      3> report Long BSR for all LCGs which have data available for transmission.
   2> else if one LCG has data available and is configured with additionalBS-TableAllowed and the amount of UL data available for transmission at Time 2 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 3 is within the buffer sizes specified in Table 6.1.3.1-3 of TS 38.321:
   2> report Refined Long BSR for all LCGs which have data available for transmission;
1> else:
   2> if more than one LCG has data available for transmission at Time 1:
      3> report Long BSR for all LCGs which have data available for transmission.
   2> else if one LCG has data available and is configured with additionalBS-TableAllowed and the amount of UL data available for transmission at Time 3 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 3 is within the buffer sizes specified in Table 6.1.3.1-3 of TS 38.321:
   2> report Refined Long BSR for all LCGs which have data available for transmission;
1> else:
   2> if more than one LCG has data available for transmission at Time 2:
   3> report Long BSR for all LCGs which have data available for transmission.
   2> else if one LCG has data available and is configured with additionalBS-TableAllowed and the amount of UL data available for transmission at Time 1 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 3 is within the buffer sizes specified in Table 6.1.3.1-3 of TS 38.321:
   2> report Refined Long BSR for all LCGs which have data available for transmission;
1> else:
   2> if more than one LCG has data available for transmission at Time 2:
      3> report Long BSR for all LCGs which have data available for transmission.
   2> else if one LCG has data available and is configured with additionalBS-TableAllowed and the amount of UL data available for transmission at Time 2 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 3 is within the buffer sizes specified in Table 6.1.3.1-3 of TS 38.321:
   2> report Refined BSR for all LCGs which have data available for transmission.
1> else:
   2> if more than one LCG has data available for transmission at Time 2:
      3> report Long BSR for all LCGs which have data available for transmission.
   2> else if one LCG has data available and is configured with additionalBS-TableAllowed and the amount of UL data available for transmission at Time 3 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 3 is within the buffer sizes specified in Table 6.1.3.1-3 of TS 38.321:
   2> report Refined Long BSR for all LCGs which have data available for transmission;
1> else:
   2> if more than one LCG has data available for transmission at Time 3:
      3> report Long BSR for all LCGs which have data available for transmission.
   2> else if one LCG has data available and is configured with additionalBS-TableAllowed and the amount of UL data available for transmission at Time 1 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 3 is within the buffer sizes specified in Table 6.1.3.1-3 of TS 38.321:
   2> report Refined Long BSR for all LCGs which have data available for transmission;
1> else:
   2> if more than one LCG has data available for transmission at Time 3:
      3> report Long BSR for all LCGs which have data available for transmission.
   2> else if one LCG has data available and is configured with additionalBS-TableAllowed and the amount of UL data available for transmission at Time 2 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.
1> if for at least one LCG configured with additionalBSR-TableAllowed (or, additionalBS-TableAllowed), the amount of UL data available for transmission at Time 3 is within the buffer sizes specified in Table 6.1.3.1-3 of TS 38.321:
   2> report Refined Long BSR for all LCGs which have data available for transmission;
1> else:
   2> if more than one LCG has data available for transmission at Time 3:
      3> report Long BSR for all LCGs which have data available for transmission.
   2> else if one LCG has data available and is configured with additionalBS-TableAllowed and the amount of UL data available for transmission at Time 3 is greater than the largest buffer size specified in Table 6.1.3.1-3:
      3> report Long BSR;
   2> else:
      3> report Short BSR.

According to an embodiment of the disclosure, a MAC layer device for which logicalChannelGroupIAB-Ext is not configured by a higher layer may operate with regard to regular and periodic BSR as follows.

For padding BSR, the MAC entity for which logicalChannelGroupIAB-Ext is not configured by upper layers shall:
1> if the number of padding bits is equal to or larger than the size of the Short BSR plus its subheader but smaller than the size of the Long BSR plus its subheader:
   2> if more than one LCG has data available for transmission when the BSR is to be built:
      3> if the number of padding bits is equal to the size of the Short BSR plus its subheader:
         4> report Short Truncated BSR of the LCG with the highest priority logical channel with data available for transmission.
      3> else:
         4> report Long Truncated BSR of the LCG(s) with the logical channels having data available for transmission following a decreasing order of the highest priority logical channel (with or without data available for transmission) in each of these LCG(s), and in case of equal priority, in increasing order of LCGID.
   2> else:
      3> report Short BSR.
1> else if for at least one LCG configured with additionalBS-TableAllowed, the amount of UL data available for transmission when the BSR is to be built is within the buffer sizes specified in Table 6.1.3.1-3 and the number of padding bits is equal to or larger than the size of the Refined Long BSR plus its subheader:
   2> report Refined Long BSR for all LCGs which have data available for transmission.
1> else if the number of padding bits is equal to or larger than the size of the Long BSR plus its subheader:
   2> report Long BSR for all LCGs which have data available for transmission.

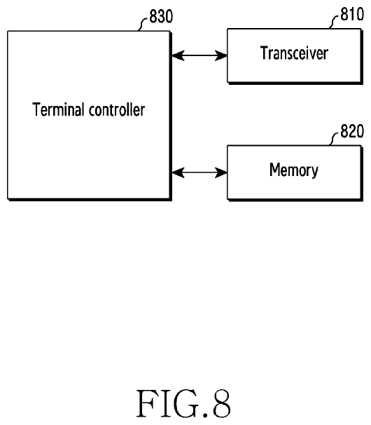

FIG. 8 illustrates the structure of a terminal according to embodiments of the disclosure.

As shown in FIG. 8, a terminal of the disclosure may include a transceiver 810, a memory 820, and a controller (or at least one processor) 830. The controller 830, the transceiver 810, and the memory 820 of the terminal may operate according to the communication methods of the terminal described above. However, the components of the terminal are not limited to the foregoing examples. For example, the terminal may include more or fewer components than the aforementioned components. Furthermore, the controller 830, the transceiver 810, and the memory 820 may be implemented in the form of a single chip.

The transceiver 810, which is a term collectively referring to a receiver of the terminal and a transmitter of the terminal, may transmit and receive signals to and from a base station, a network entity, or another terminal. The signals transmitted to and received from the base station may include control information and data. To this end, the transceiver 810 may include a radio frequency (RF) transmitter that up-converts and amplifies the frequency of the transmitted signal, and an RF receiver that low-noise amplifies and down-converts the frequency of the received signal. However, this is only an embodiment of the transceiver 810, and the components of the transceiver 810 are not limited to the RF transmitter and RF receiver.

Further, the transceiver 810 may include a wired or wireless transceiver, and may include various configurations for transmitting and receiving signals. Further, the transceiver 810 may receive signals over a wireless channel and output the received signals to the controller 830, and transmit signals output from the controller 830 over a wireless channel. Further, the transceiver 810 may receive communication signals and output the communication signals to the controller 830, and may transmit the signals output from the controller 830 to a base station or network entity via a wired or wireless network.

The memory 820 may store programs and data required for operation of the terminal. In addition, the memory 820 may store control information or data included in signals acquired by the terminal. The memory 820 may include a storage medium, such as ROM, RAM, hard disks, CD-ROMs, and DVDs, or a combination of storage media.

The controller 830 may control a series of processes to enable the terminal to operate according to the embodiments of the disclosure described above. The controller 830 may include at least one or more processors. For example, the controller 830 may include a communication processor (CP) that performs controls for communications and an application processor (AP) that controls higher layers, such as applications.

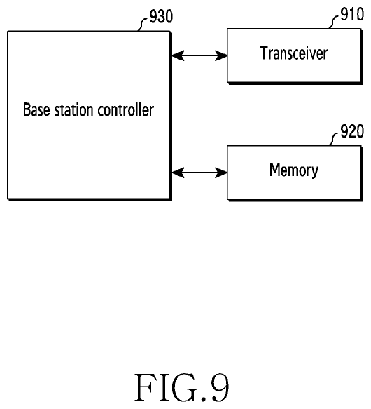

FIG. 9 illustrates the structure of a base station according to embodiments of the disclosure.

As shown in FIG. 9, a base station of the disclosure may include a transceiver 910, a memory 920, and a controller (or at least one processor) 930. The controller 930, the transceiver 910, and the memory 920 of the base station may operate according to the communication methods of the base station described above. However, the components of the base station are not limited to the foregoing examples. For example, the base station may include more or fewer components than the aforementioned components. Furthermore, the controller 930, the transceiver 910, and the memory 920 may be implemented in the form of a single chip.

The transceiver 910, which is a term collectively referring to a receiver of the base station and a transmitter of the base station, may transmit and receive signals to and from a terminal and/or a network entity. The transmitted/received signals may include control information and data. To this end, the transceiver 910 may include an RF transmitter that up-converts and amplifies the frequency of the transmitted signal, and an RF receiver that low-noise amplifies and down-converts the frequency of the received signal. However, this is only an embodiment of the transceiver 910, and the components of the transceiver 910 are not limited to the RF transmitter and RF receiver. The transceiver 910 may include a wired or wireless transceiver, and may include various components for transmitting and receiving signals.

Further, the transceiver 910 may receive signals over a communication channel (e.g., a wireless channel) and output the received signals to the controller 930, and transmit signals output from the controller 930 over a wireless channel. Further, the transceiver 910 may receive communication signals and output the communication signals to the processor, and may transmit the signals output from the processor to a terminal or network entity via a wired or wireless network.

The memory 920 may store programs and data required for operation of the base station. In addition, the memory 920 may store control information or data included in signals acquired by the base station. The memory 920 may include a storage medium, such as ROM, RAM, hard disks, CD-ROMs, and DVDs, or a combination of storage media.

The controller 930 may control a series of processes to enable the base station to operate according to the embodiments of the disclosure described above. The controller 930 may include at least one or more processors. Methods disclosed in the claims and/or methods according to the embodiments described in the specification of the disclosure may be implemented by hardware, software, or a combination of hardware and software.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Furthermore, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. For example, a part or all of an embodiment may be combined with a part or all of one or more other embodiments, and it is natural that an implementation of such combination also corresponds to an embodiment proposed by the disclosure. Therefore, the scope of the disclosure should not be defined as being limited to the embodiments set forth herein, but should be defined by the appended claims and equivalents thereof.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
identifying a logical channel group (LCG) configured with an additional buffer size table; and
in case that the LCG configured with the additional buffer size table has data available for transmission, transmitting, to a base station, a first long buffer status report (BSR),
wherein the first long BSR corresponds to the additional buffer size table, and
wherein an amount of the data available for transmission is within buffer sizes of the additional buffer size table.

2. The method of claim 1, further comprising:
in case that more than one LCG has data available for transmission when a medium access control (MAC) protocol data unit (PDU) is to be built, transmitting, to the base station, a second long BSR.

3. The method of claim 2, further comprising:
in case that one LCG has data available for transmission when the MAC PDU is to be built, transmitting, to the base station, a short BSR.

4. The method of claim 2, wherein the first long BSR is identified by an MAC subheader including extended logical channel identity (eLCID) corresponding to a specific value.

5. The method of claim 1, wherein the first long BSR includes a logical channel group field indicating a presence of a buffer size field for a logical channel group, and a buffer table field indicating which buffer size table is used to set the buffer size field for the logical channel group.

6. The method of claim 1, wherein the additional buffer size table is configured for the LCG by a radio resource control (RRC) signaling.

7. The method of claim 1, wherein the buffer size field of the first long BSR includes 8 bits.

8. The method of claim 2, wherein the additional buffer size table is different from a legacy buffer size table for the second long BSR.

9. The method of claim 8, wherein a buffer size interval for a specific buffer size level of the additional buffer size table is narrower than a buffer size interval for a corresponding buffer size level of the legacy buffer size table.

10. The method of claim 1, wherein the first long BSR includes a refined long BSR.

11. A terminal in a wireless communication system, the terminal comprising:
a transceiver; and
a controller coupled with the transceiver and configured to:
identify a logical channel group (LCG) configured with an additional buffer size table, and
in case that the LCG configured with the additional buffer size table has data available for transmission, transmit, to a base station, a first long buffer status report (BSR),
wherein the first long BSR corresponds to the additional buffer size table, and
wherein an amount of the data available for transmission is within buffer sizes of the additional buffer size table.

12. The terminal of claim 11, wherein the controller is further configured to:
in case that more than one LCG has data available for transmission when a medium access control (MAC) protocol data unit (PDU) is to be built, transmit, to the base station, a second long BSR.

13. The terminal of claim 12, wherein the controller is further configured to:
in case that one LCG has data available for transmission when the MAC PDU is to be built, transmit, to the base station, a short BSR.

14. The terminal of claim 12, wherein the first long BSR is identified by an MAC subheader including extended logical channel identity (eLCID) corresponding to a specific value.

15. The terminal of claim 11, wherein the first long BSR includes a logical channel group field indicating a presence of a buffer size field for a logical channel group, and a buffer table field indicating which buffer size table is used to set the buffer size field for the logical channel group.

16. The terminal of claim 11, wherein the additional buffer size table is configured for the LCG by a radio resource control (RRC) signaling.

17. The terminal of claim 11, wherein the buffer size field of the first long BSR includes 8 bits.

18. The terminal of claim 12, wherein the additional buffer size table is different from a legacy buffer size table for the second long BSR.

19. The terminal of claim 18, wherein a buffer size interval for a specific buffer size level of the additional buffer size table is narrower than a buffer size interval for a corresponding buffer size level of the legacy buffer size table.

20. The terminal of claim 11, wherein the first long BSR includes a refined long BSR.
